(19) United States
(12) Patent Application Publication
(10) Pub. No.: US 2026/0299550 A1
(43) Pub. Date: Oct. 1, 2026

(54) DISPLAY DEVICE AND NON-TRANSITORY COMPUTER-READABLE MEDIUM STORING PROGRAM FOR MACHINING TOOL

(71) Applicant: FANUC CORPORATION, Yamanashi (JP)

(72) Inventor: Masashi YASUDA, Yamanashi (JP)

(73) Assignee: FANUC CORPORATION, Yamanashi (JP)

(21) Appl. No.: 19/481,168

(22) PCT Filed: May 11, 2023
(86) PCT No.: PCT/JP2023/017817

§ 371 Date: Nov. 3, 2025

(51) Int. Cl. G05B 19/406; G05B 19/401

(52) U.S. Cl. CPC G05B 19/406; G05B 19/401; G05B 2219/32398; G05B 2219/49055

(57) ABSTRACT

The present invention provides a technology that can present a setting range of a machining condition on the basis of a plurality of viewpoints to be considered in swing machining in a machining tool. This display device 1 of a machining tool comprises: a first machining condition acquisition unit 11 that acquires, as a first machining condition, at least one of a spindle rotation speed, a feed speed, frequency parameters, and amplitude parameters included in machining conditions; a calculation reference acquisition unit 12 that acquires two or more calculation references for calculating a setting range of a second machining condition that is the at least one machining condition not acquired as the first machining condition among the machining conditions; a setting range calculation unit 14 that calculates a setting range of the second machining condition on the basis of the first machining condition and the calculation references; and a display control unit 15 that displays the setting range of the second machining condition on the display unit 20.

### TECHNICAL FIELD

The present disclosure relates to a display device and a program for a machine tool.

### BACKGROUND ART

In a conventionally known technique pertaining to a machine tool that performs oscillation machining in which chips are shredded by causing a tool to oscillate with respect to a workpiece, various types of parameters, e.g., feed speed, are displayed in order to set machining conditions (see, for example, Patent Document 1 and Patent Document 2).

### CITATION LIST

### Patent Document

Patent Document 1: Japanese Patent No. 6843313
Patent Document 2: PCT International Publication No. WO2021/167014

### DISCLOSURE OF THE INVENTION

### Problems to be Solved by the Invention

Patent Document 1 indicates that setting ranges for machining conditions are calculated in view of one advantage that chip shredding can occur. While it is relatively easy to decide on machining conditions for oscillation cutting in view of one advantage, it has been difficult to decide on machining conditions such that a plurality of advantages are achieved.

Patent Document 2 indicates that a recommended value for achieving a plurality of advantages is displayed for a machining condition. In this technique, however, a single recommended value is merely presented for the second machining condition, so it is difficult to decide on machining conditions in consideration of other advantages pertaining to, for example, maintenance and environment, which are difficult to take into consideration only in view of the internals of the control device. In Patent Document 1, machining conditions are calculated in the form of ranges in the end, but there is still room for improvement in deciding on machining conditions in view of a wide variety of advantages.

The present disclosure is provided in view of the problems noted above, and an object thereof is to provide a technique for allowing setting ranges for machining conditions in oscillation machining by a machine tool to be presented on the basis of a plurality of advantages that should be taken into consideration.

### Means for Solving the Problems

The present disclosure is a display device for a machine tool that performs oscillation machining while causing a cutting tool and a workpiece to oscillate relative to each other, the display device including: a first machining condition acquisition unit that acquires, as a first machining condition, at least one from among a spindle rotation number, a feed speed, a frequency parameter, or an amplitude parameter included in machining conditions; a calculation criterion acquisition unit that acquires two or more calculation criteria for calculating a setting range for a second machining condition that is at least one machining condition not acquired as the first machining condition from among the machining conditions; a setting range calculation unit that calculates a setting range for the second machining condition on the basis of the first machining condition and the calculation criteria; and a display control unit that displays the setting range of the second machining condition on a display unit.

The present disclosure is also a program for causing a computer for a machine tool that performs oscillation machining while causing a cutting tool and a workpiece to oscillate relative to each other to implement: a first machining condition acquisition function of acquiring, as a first machining condition, at least one from among a spindle rotation number, a feed speed, a frequency parameter, or an amplitude parameter included in machining conditions; a calculation criterion acquisition function of acquiring two or more calculation criteria for calculating, on the basis of the first machining condition, a setting range for a second machining condition that is at least one machining condition not acquired as the first machining condition from among the machining conditions; and a setting range calculation function of calculating a setting range for the second machining condition on the basis of the first machining condition and the calculation criteria.

### BRIEF DESCRIPTION OF THE DRAWINGS

FIG. 1 is a functional block diagram of a display device for a machine tool according to a first embodiment;

FIG. 2 is a flowchart illustrating an example of the processing flow of display control performed by the display device according to the first embodiment;

FIG. 3 illustrates an image example displayed by the display device on a display unit when selecting a second machining condition;

FIG. 4 illustrates an image example in which the setting range of the second machining condition is displayed by the display device on the display unit;

FIG. 5 is a functional block diagram of a calculation criterion acquisition unit of a display device according to a second embodiment; and

FIG. 6 is a functional block diagram of a display device for a machine tool according to a third embodiment.

### PREFERRED MODE FOR CARRYING OUT THE INVENTION

The following describes embodiments of the present disclosure in detail by referring to the drawings. In the descriptions of the second embodiment and thereafter, like components are given like reference marks to those in the first embodiment, and descriptions thereof are omitted as appropriate herein.

### First Embodiment

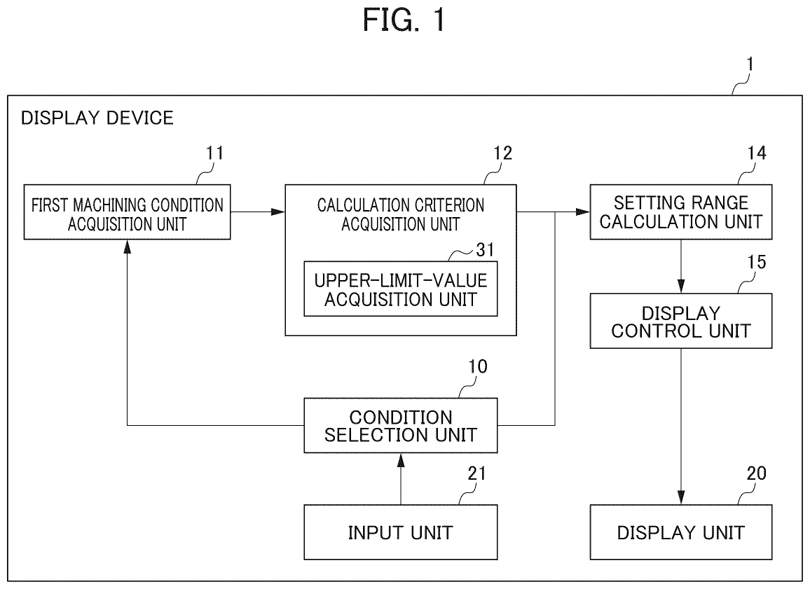

FIG. 1 is a functional block diagram of a display device 1 for a machine tool according to a first embodiment. The display device 1 according to the first embodiment is a computer that displays, on a display unit 20, various types of information on a machine tool for performing oscillation machining while causing a cutting tool and a workpiece to oscillate relative to each other. For example, the display device 1 is used while connected to a control device (not shown) constituted by a computer for controlling the machine tool. The display device 1 assists in setting machining conditions for oscillation cutting.

The machine tool subjects a workpiece to machining by means of a cutting tool by operating at least one spindle for rotating the cutting tool and the workpiece relative to each other and at least one feed axis for moving the cutting tool relative to the workpiece. The machine tool performs various types of machining on the basis of a machining program.

The shape of a workpiece is not limited in the machining performed by the machine tool according to the present embodiment. In particular, the present invention can be applied in both a case where a plurality of feed axes (Z-axis and X-axis) are necessary because of a workpiece having a tapered portion or an arc-shaped portion on a surface to be machined and a case where a feed axis for one specific axis (Z-axis) is sufficient because of a workpiece having a column shape or a cylindrical shape.

The following describes the hardware configuration of the display device 1 for the machine tool. For example, the display device 1 is formed using a computer provided with memories such as a read only memory (ROM) and a random access memory (RAM), a control processing unit (CPU), and a communication control unit, which are connected to each other via a bus. The display device 1 further includes a display unit 20 that displays various types of information, and an input unit 21 with which an operator inputs various types of information. For example, the display unit 20 is formed from a display that displays various types of information. The input unit 21 is an operation means, e.g., touch panel, keyboard, button.

The display device 1 for the machine tool may be formed as a computer numerical controller (CNC) or may be connected to a host computer (not shown) such as a CNC or a programmable logic controller (PLC). In addition to the machining program, machining conditions and the like, e.g., rotation speed, may be input from the host computer to the display device 1 for the machine tool. Alternatively, the display device 1 may be an external computer for simulating oscillation cutting that is not connected to the machine tool.

The following describes functional units implemented in the display device 1. The display device 1 includes a condition selection unit 10, a first machining condition acquisition unit 11, a calculation criterion acquisition unit 12, an upper-limit-value acquisition unit 31, a setting range calculation unit 14, and a display control unit 15 as functional units. The CPU, memories, and a control program stored in the memories cooperate with each other, thereby implementing the functional units of the display device 1.

The condition selection unit 10 is a condition selection function of selecting a first machining condition and a second machining condition from machining conditions. For example, the first machining condition and the second machining condition may be designated by an operator for the display device 1 via, for example, the input unit 21 or an external computer in accordance with a visual indication on the display unit 20 for the display device 1, or may be designated in advance by, for example, the machining program or a setting parameter of the machine tool. Furthermore, one or more first machining conditions and one or more second machining conditions may be designated.

The following describes machining conditions. The machining conditions include information necessary for machining, such as a spindle rotation number S (1/min), the amount F of feed per rotation of the spindle (mm/rev), a workpiece diameter (mm), a command position for the feed axis, and oscillation conditions. The amount of feed per rotation of the spindle (mm/rev) may be calculated according to the combination of the rotation number (1/min) of the spindle and the feed speed (mm/min) of the cutting tool.

The following describes oscillation conditions included in machining conditions. The oscillation conditions include, as information for uniquely identifying an oscillatory waveform, at least a frequency parameter, which is information pertaining to the oscillation frequency of the cutting tool or the workpiece, and an amplitude parameter, which is information pertaining to the oscillation amplitude of the cutting tool or the workpiece. The frequency parameter may be the number of relative vibrations between the cutting tool and the workpiece per rotation or per unit time. Alternatively, the frequency parameter may be the cycle parameter of a forward/rearward movement operation. The amplitude parameter may be information pertaining to an oscillation amplitude specific to the amount of relative feed between the cutting tool and the workpiece per rotation, or the distance parameter of the forward/rearward movement operation. The cycle parameter of the forward/rearward movement operation and the distance parameter of the forward/rearward movement operation may be decided on according to, for example, a forward movement speed, a rearward movement speed, a forward movement distance, a rearward movement distance, a spindle rotation number, and a control cycle. The frequency parameter and the amplitude parameter may be decided on according to, for example: the spindle rotation number; a per-rotation feed speed; a per-minute feed speed; a frequency multiplying factor, which is the number of relative vibrations between the cutting tool and the workpiece per rotation; and an amplitude multiplying factor, which is an oscillation amplitude specific to the amount of relative feed between the cutting tool and the workpiece per rotation.

In the present embodiment, an oscillation frequency f(Hz) per rotation of the spindle or an oscillation frequency multiplying factor I (times) is used as the frequency parameter. The oscillation frequency multiplying factor I (times) may be directly designed, or may be calculated from an oscillation frequency (Hz) and the rotation number S (1/min) of the spindle after the oscillation frequency (Hz) is designed.

Meanwhile, an oscillation amplitude A (mm) specific to the magnitude of the amount of feed per rotation of the spindle or an oscillation amplitude multiplying factor K (times) indicating the magnitude of the oscillation amplitude is used as the amplitude parameter. The oscillation amplitude multiplying factor K (times) may also be directly designated.

In addition, the amount of feed per minute may be used as a machining condition. Meanwhile, a forward movement amount, a forward movement speed, a rearward movement amount, a rearward movement speed, a control cycle, the number of edges, and the like can be used as machining conditions instead of the feed speed, the frequency parameter, and the amplitude parameter.

The first machining condition acquisition unit 11 is a first machining condition acquisition function of acquiring a first machining condition from among a plurality of machining conditions for performing oscillation machining.

The calculation criterion acquisition unit 12 is a calculation criterion acquisition function of acquiring two or more calculation criteria for calculating a setting range for at least one preset second machining condition from among the machining conditions. For example, a condition under which chip shredding can occur is calculated as a calculation criterion.

The calculation criterion acquisition unit 12 in the present embodiment has an upper-limit-value acquisition unit 31. The upper-limit-value acquisition unit 31 is an upper-limit-value acquisition function of acquiring the upper limit value of an oscillation status (parameter) used to decide on one calculation criterion.

Let L_{A} be the upper limit value of the oscillation status, and L_{B} be the lower limit value thereof. The oscillation status is, for example, an upper-limit frequency value (L_{A}>S×1), an upper-limit amplitude value (L_{A}>F×K>L_{B}), an upper-limit maximum oscillation speed value (L_{A}>F×S+(F×K)×(2π×S×I)/2), an upper-limit maximum oscillation acceleration value (L_{A}>(F×K)×(2π×S×I)²/2), or an upper-limit maximum oscillation jerk value (L_{A}>(F×K)×(2π×S×I)³/2). An upper-limit return speed value or the like may also be used as another oscillation status. In this way, the upper limit value and the lower limit value of the oscillation status can be set for various parameters pertaining to oscillation conditions.

The setting range calculation unit 14 calculates a setting range for the second machining condition on the basis of the first machining condition and the calculation criteria. Note that the calculation method used by the setting range calculation unit 14 is described hereinafter.

The display control unit 15 is a display control function of displaying, on the display unit 20, various types of information on the display device 1 and information pertaining to the result of an operator input. The display control unit 15 performs display control for displaying, on the display unit 20, an image based on the setting range of the second machining condition that has been calculated by the setting range calculation unit 14.

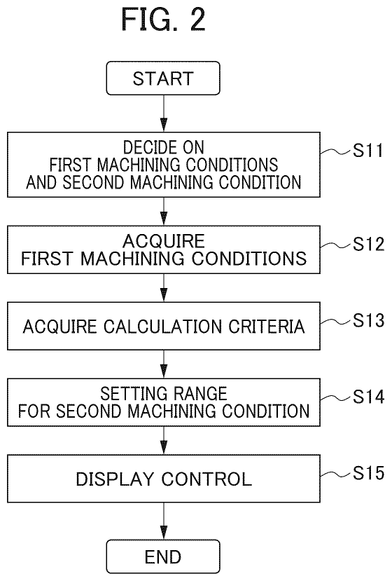

The following describes the processing flow of the display control by referring to FIG. 2. FIG. 2 is a flowchart illustrating an example of the processing flow of the display control performed by the display device 1 according to the first embodiment. Note that the order indicated in the flowchart in which processing operations are performed and the details of the processing operations are nothing but examples and can be changed as appropriate.

First, the condition selection unit 10 decides on first machining conditions and a second machining condition from among machining conditions on the basis of input information from an operator (Step S11).

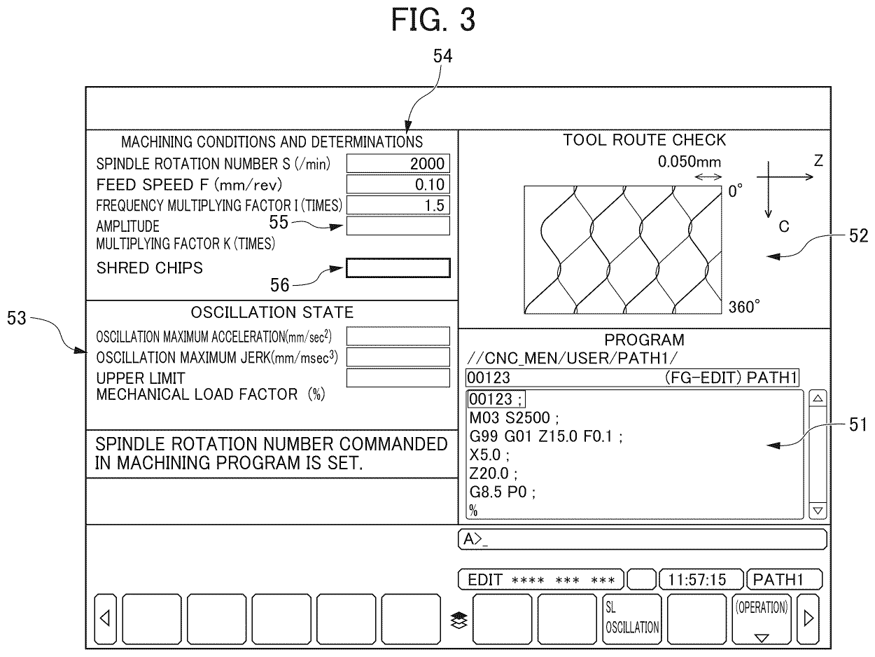

FIG. 3 illustrates an image example displayed by the display device 1 on the display unit 20 when selecting a second machining condition. The image depicted in FIG. 3 includes a program indication 51 indicating the details of a machining program, a tool path check indication 52 indicating a machining path for a cutting tool, an acceleration information indication 53 displaying information pertaining to, for example, a maximum acceleration, and a machining condition indication 54 displaying machining conditions.

In the example of FIG. 3, the machining condition indication 54 already has a “spindle rotation number S=2000,” a “feed speed F=0.10,” and an “oscillation frequency multiplying factor I=1.5” input thereto, and a field 55 for an oscillation amplitude multiplying factor K is blank. A field 56 for indicating chip cutting permission/prohibition in the machining condition indication 54 is also blank. Upon the operator selecting the field 55 for the oscillation amplitude multiplying factor K through, for example, a cursor operation on the input unit 21, the selected portion is displayed in a different mode (e.g., different color) from other portions.

Upon the blank field 55 being selected, the condition selection unit 10 determines that the oscillation amplitude multiplying factor K has been designated as a second machining condition, and decides on the oscillation amplitude multiplying factor K as the second machining condition. Then, the spindle rotation number S, the feed speed F, and the oscillation frequency multiplying factor I that are not selected as the second machining condition from among the machining conditions are decided on as first machining conditions. In a case where there is a blank field other than the field selected by the operator, the process of reporting this fact to the operator may be added.

Next, the first machining condition acquisition unit 11 acquires the first machining conditions on the basis of input information from the operator or information preset in the display device 1 (Step S12). In this example, the first machining condition acquisition unit 11 acquires a “spindle rotation number S=2000,” a “feed speed F=0.10,” and an “oscillation frequency multiplying factor I=1.5” as the first machining conditions. The second machining condition is the oscillation amplitude multiplying factor K. The feed speed may be the amount of feed per rotation of the spindle, may be the amount of feed per time, or may be the amount of feed per oscillation. In this example, the amount of feed per rotation of the spindle is acquired as the feed speed.

Subsequently, the calculation criterion acquisition unit 12 acquires calculation criteria for calculating a setting range for the second machining condition on the basis of the information preset in the display device 1 (Step S13). In this example, two matters of achieving an oscillation operation capable of causing chip shredding and also achieving the oscillation operation without the upper-limit acceleration value being exceeded are acquired as calculation criteria. The upper-limit acceleration value is acquired by the upper-limit-value acquisition unit 31. For example, the upper-limit-value acquisition unit 31 acquires 9869.6 (mm/s²) as the upper limit acceleration.

Next, the setting range calculation unit 14 calculates a setting range for the second machining condition on the basis of the first machining conditions acquired by the first machining condition acquisition unit 11 and the calculation criteria acquired by the calculation criterion acquisition unit 12 (Step S14). In this example, the value of the oscillation amplitude multiplying factor K is set so as to satisfy the numerical expression (1) below, which is a calculation criterion indicating that an oscillation operation capable of causing chip shredding is achieved, and the numerical expression (2) below, which is a calculation criterion indicating that the oscillation operation is achieved without the upper-limit acceleration value being exceeded. For example, the setting range calculation unit 14 calculates an “oscillation amplitude multiplying factor K=1.0 to 2.0” as a setting range for the second machining condition.

$$\begin{matrix}Formula 1 & \\ K > 1 / \vert sin ( π \times I ) \vert & NUMERICAL EXPRESSION ( 1 )\end{matrix}$$

$$\begin{matrix}Formula 2 & \\ {A}_{max} > ( K \times F ) \times {( 2 π \times S \times I )}^{2} / 2 & NUMERICAL EXPRESSION ( 2 )\end{matrix}$$

Numerical expression (1) is indicated as a condition under which an oscillation operation capable of causing chip shredding is achieved. Under this condition, the tool path routes in an n-th rotation and an (n+1)-th rotation have an overlap therebetween and thus an air cut occurs. In actual situations, however, when the distance of a cutting route is sufficiently short, chip shredding may occur without the occurrence of an air cut. Accordingly, for the condition under which an oscillation operation capable of causing chip shredding is achieved, the determination may be made with a margin being provided in numerical expression (1), or it may be determined whether chip shredding can occur under the condition by referring to the machining conditions I and K and actual-machining result table data indicating whether chip shredding was capable of being actually caused to occur at that time.

Then, the display control unit 15 performs display control for displaying, on the display unit 20, an image including the setting range of the oscillation amplitude multiplying factor K, i.e., the second machining condition, that has been calculated by the setting range calculation unit 14 (Step S15).

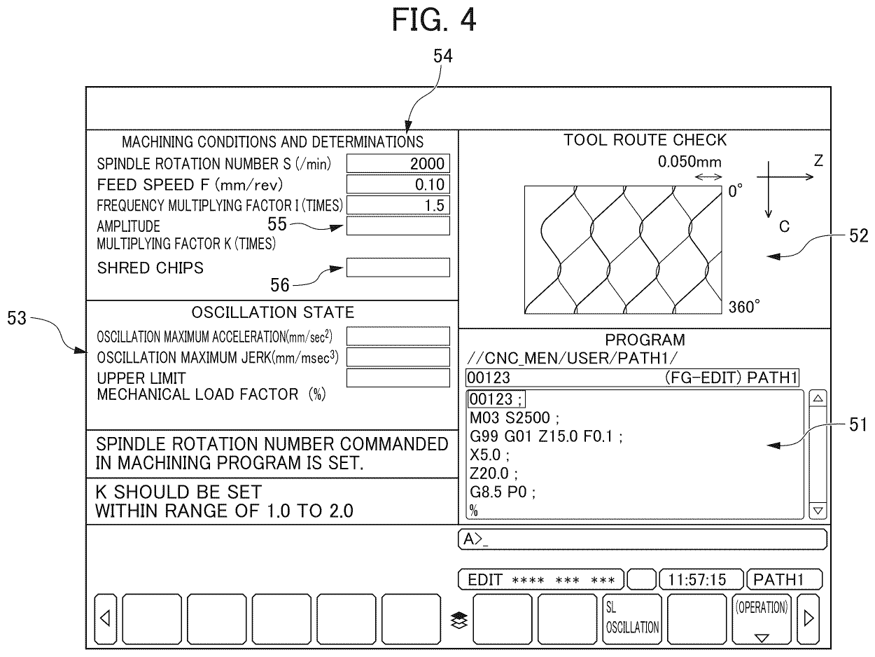

FIG. 4 illustrates an image example in which the setting range of the second machining condition is displayed by the display device 1 on the display unit 20. In the example depicted in FIG. 4, a setting range of 1.0 to 2.0 for the oscillation amplitude multiplying factor K set as the second machining condition in the machining condition indication 54 is indicated in a lower-left field on the screen. Thus, the operator can set the oscillation amplitude multiplying factor K to an arbitrary value of 1.0 to 2.0 and thus can make a condition setting such that chip shredding can occur without exceeding the upper-limit acceleration.

In the actual situation, further examination is necessary to choose a specific value within the range of 1.0 to 2.0 of the oscillation amplitude multiplying factor K, and further examination and decisions need to be made on the operator side for a wide range of factors that are difficult to take into consideration for the control device, e.g., quality of the to-be-machined surface of a workpiece, machine characteristics, chip length, machine maintainability, energy saving. However, indicating the setting range of 1.0 to 2.0 for K, i.e., an essential condition, will make it much easier to make adjustments than in the prior art. In this example, although a setting range is calculated in view of only the two advantages of being capable of causing chip shredding and not exceeding the upper-limit acceleration, the setting range can be further narrowed down by providing the calculation criterion acquisition unit with as many calculation criteria considered by the operator as possible. However, it would be significantly difficult to provide the control device with calculation criteria based on all of the advantages noted above, so calculating a range is significant, and the operator may make determinations on remaining factors.

Assume that the first machining condition acquisition unit 11 acquires a “spindle rotation number S=2000,” a “feed speed F=0.10,” and an “oscillation amplitude multiplying factor K=1.5” as first machining conditions. The second machining condition is the oscillation frequency multiplying factor I. Similarly, when calculating, as a calculation criterion, a setting range for the frequency multiplying factor I in accordance with numerical expressions (1) and (2), the setting range calculation unit 14 calculates an “oscillation frequency multiplying factor I=0.233 to 0.767 or 1.233 to 1.732” as a setting range for the second machining condition. When the frequency multiplying factor I is the second machining condition, noncontinuous setting ranges are often acquired like this, thereby making situations significantly difficult to deal with. Thus, it is especially highly demanded to calculate a setting range such as that in the present technique.

In the example described above, K or I is designated as the second machining condition. However, S and F may be designated as first machining conditions, and both K and I may also be designated as second machining conditions. In this case, the setting ranges of K and I may be two-dimensionally indicated in the form of, for example, a graph.

In this example, calculation is performed with the number of tool edge being 1. When there are a plurality of tool edges, the number of tool edges can be acquired, and calculation may be performed in consideration of the number of tool edges.

The following effects are exhibited by the display device 1 for the machine tool according to the first embodiment that performs oscillation machining while moving the cutting tool and a workpiece relative to each other.

The display device 1 for a machine tool according to the present embodiment includes: a first machining condition acquisition unit 11 that acquires, as a first machining condition, at least one from among a spindle rotation number, a feed speed, a frequency parameter, or an amplitude parameter included in machining conditions; a calculation criterion acquisition unit 12 that acquires two or more calculation criteria for calculating, on the basis of the first machining condition, a setting range for a second machining condition that has not been acquired as the first machining condition from among the machining conditions; a setting range calculation unit 14 that calculates a setting range for the second machining condition on the basis of the first machining condition and the calculation criteria; and a display control unit 15 that displays the setting range of the second machining condition on a display unit 20.

Accordingly, the setting ranges of machining conditions achieving a plurality of advantages can be presented to the operator. Hence, the operator can examine machining conditions in view of a wide variety of advantages. As a result, machining conditions can be easily decided on in consideration of advantages pertaining to, for example, maintenance and environment, which are difficult to take into consideration only in view of the inside of the control device for the machine tool.

In the present embodiment, the calculation criterion acquisition unit 12 acquires at least a calculation criterion for calculating a setting range such that machining operations based on the first and second machining conditions can cause chip shredding. It is relatively easy to find a machining condition that only satisfies the need to allow chip shredding, which is special and complicated, to occur. However, it is highly difficult to find a machining condition that also achieves other advantages. In this regard, the features of the present embodiment allow a setting range for the second machining condition under which chip shredding can be caused and other advantages are also achieved to be presented to the operator.

In the present embodiment, the display device 1 further includes an upper-limit-value acquisition unit 31 that acquires an upper limit value for a parameter set for oscillation machining, and the calculation criterion acquisition unit 12, 12A acquires at least a calculation criterion for calculating a setting range such that the oscillation parameter calculated from the second machining condition assumes a value corresponding to the upper limit value. In this way, setting ranges satisfying the upper limit values of various parameters that affect oscillation machining are automatically calculated and presented, so that the operator can more easily set stable oscillation machining.

In the present embodiment, the display device 1 further includes a condition selection unit 10 that selects a first machining condition and a second machining condition from machining conditions. Thus, in accordance with, for example, an operator input or the setting of the display device 1, a first machining condition and a second machining condition can be arbitrarily selected from machining conditions, and initial settings can be changed.

In the present embodiment, the display device 1 further includes an input unit 21 with which the operator selects any of the machining conditions, and the condition selection unit 10 selects the machining condition selected using the input unit 21 as a second machining condition, and selects a machining condition differing from the one selected using the input unit 21 as a first machining condition. In this way, a first machining condition is automatically set simply by setting a second machining condition, so that operations for displaying a setting range for the second machining condition can be further simplified.

### Second Embodiment

The following describes a display device 1 according to a second embodiment that performs different display control from the display device 1 of the first embodiment. The configuration of the display device 1 of the second embodiment is similar to that in the first embodiment.

The second embodiment differs from the first embodiment in terms of the calculation criterion acquired by a calculation criterion acquisition unit 12A and in terms of the method for calculating a setting range for a second machining condition on the basis of the calculation criterion.

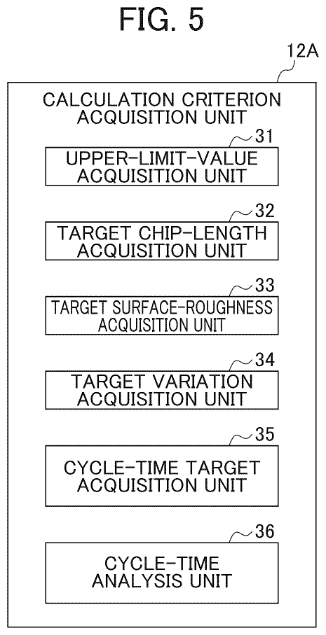

FIG. 5 is a functional block diagram of the calculation criterion acquisition unit 12A of the display device 1 according to the second embodiment. As depicted in FIG. 5, the calculation criterion acquisition unit 12A in the second embodiment includes an upper-limit-value acquisition unit 31, a target chip-length acquisition unit 32, a target surface-roughness acquisition unit 33, a target variation acquisition unit 34, a cycle-time target acquisition unit 35, and a cycle-time analysis unit 36. The configuration of the upper-limit-value acquisition unit 31 is the same as that in the first embodiment.

The following describes another feature of the upper-limit-value acquisition unit 31, namely, a calculation criterion for calculating a setting range on the basis of a target value for each individual parameter. The target value herein may also be referred to as an allowable value for an operation. The target value may be a calculated theoretical value theoretically calculated, or may be an output value of a learning model based on a past performance or a reference value from a database. Alternatively, the target value may be information preset for the display device 1 or may be based on input information from the operator.

The target chip-length acquisition unit 32 is a target chip-length acquisition function of acquiring a target chip length, which is a target value for a chip length, as a calculation criterion. The setting range calculation unit 14 calculates a setting range such that a value corresponding to the target chip length is achieved. In the second embodiment, the setting range calculation unit 14 calculates a setting range such that a chip length calculated from a first machining condition and a second machining condition is lower than the chip length target value acquired by the target chip-length acquisition unit 32. For example, a setting range is calculated such that parameters such as the oscillation frequency multiplying factor I and the oscillation amplitude multiplying factor K of a publicly known function f(I, K) for calculating the chip length satisfy “upper-limit chip length value L_{A}>f(I, K)>lower-limit chip length value L_{B}.” For example, with respect to the publicly known function f(I, K), “chip length=πΦ/I” may be used as a simple chip-length calculation equation, where Φ [mm] is a workpiece diameter, or a more accurate calculation method may be used that includes: calculating, from I and K as a numerical calculation, a phase difference with respect to the workpiece for the area from one end to another end of a tool path where an air cut occurred; and calculating a chip length from the phase difference and Φ.

In this way, the setting range of the second machining condition satisfying conditions for a desired chip length can be presented to the operator.

The target surface-roughness acquisition unit 33 is a target surface-roughness acquisition function of acquiring target surface roughness, which is a target value for surface roughness, as a calculation criterion. The setting range calculation unit 14 calculates a setting range such that a value corresponding to the target surface roughness is achieved. In the second embodiment, the setting range calculation unit 14 calculates a setting range such that surface roughness calculated from a first machining condition and a second machining condition is lower than the surface roughness target value acquired by the target surface-roughness acquisition unit 33. For example, a setting range is calculated such that parameters such as the feed speed F, the oscillation frequency multiplying factor I, and the oscillation amplitude multiplying factor K of a publicly known function f(F, I, K) for calculating target surface roughness satisfy “upper-limit surface roughness value L_{A}>f(F, I, K).” For example, with respect to the publicly known function f(F, I, K), a nose R [mm] may be separately acquired, the surface roughness during oscillation cutting may be calculated through a numerical calculation on the basis of the nose R and a cutting route calculated on the basis of F, I, and K, and a setting range may be calculated such that the surface roughness during oscillation cutting satisfies the upper-limit surface roughness value L_{A}. In this way, the setting range of the second machining condition satisfying conditions for desired target surface roughness can be presented to the operator.

The target variation acquisition unit 34 is a target variation indicator acquisition function of acquiring a target variation indicator, which is a target value for an indicator pertaining to variations of the difference in surface roughness between workpiece phases, as a calculation criterion. The indicator pertaining to variations pertains to variations in air cut sites, and is a numerical value indicating variations in to-be-machined surfaces.

The following describes variations of the difference in surface roughness between workpiece phases. For example, when the phase per spindle rotation deviates by a half cycle, the phase of a crest portion of the previous tool path matches, at a specific spindle phase, the phase of a trough portion of the current tool path. At the specific phase, e.g., at around a certain spindle phase angle of 120°, the amount of feed per spindle rotation exhibits a large change, and, due to the influence of, for example, the corner radius of the tool leading end, the workpiece surface may have strong unevenness, thereby providing high surface roughness. At around a spindle phase of 180°, by contrast, the amount of feed per spindle rotation may be always constant, thereby providing low surface roughness. In such a situation, the surface roughness variations increase in accordance with the spindle phase. Accordingly, the surface roughness variations corresponding to the spindle phase can be decreased by performing control such that the spindle phase that provides an increased amount of feed per spindle rotation is prevented from becoming constant.

For example, an indicator pertaining to variations of the difference in surface roughness between workpiece phases is not the surface roughness, but may be determined in advance with the surface roughness variations between the workpiece phases being defined as a standard deviation. In the second embodiment, the display device 1 stores the relationship between the standard deviation and the frequency multiplying factor in the form of a table or a function.

The setting range calculation unit 14 calculates a setting range such that a value corresponding to the target variation indicator is achieved. In the second embodiment, the setting range calculation unit 14 calculates a setting range such that a variation indicator calculated from a first machining condition and a second machining condition is lower than a target variation indicator acquired for the surface roughness by the target variation acquisition unit 34. For example, a setting range is calculated such that a parameter such as the oscillation frequency multiplying factor I of a function f(I) corresponding to the table noted above satisfies “target variation indicator (upper limit value) L_{A}>f(I).” In this way, the setting range of the second machining condition satisfying variation conditions for desired surface roughness can be presented to the operator.

The cycle-time target acquisition unit 35 acquires a cycle-time target value for a machining operation. The cycle-time analysis unit 36 is a cycle-time analysis function of performing the process of calculating a cycle time. The setting range calculation unit 14 calculates a setting range such that a value corresponding to the cycle-time target value is achieved. In the second embodiment, the setting range calculation unit 14 calculates a setting range such that a cycle time calculated from a first machining condition and a second machining condition by the cycle-time analysis unit 36 is lower than the cycle-time target value acquired by the cycle-time target acquisition unit 35.

For example, a setting range is calculated such that parameters such as the spindle rotation number S and the feed speed F of a publicly known function f(S, F) for calculating a cycle time satisfy “cycle-time allowable value (upper limit value) L_{A}>f(S, F).”

With respect to the publicly known function f(S, F), for example, machining simulation facilities are used in combination with each other with S and F as variables, such that a cycle time at the variables S and F that have been set is output. A setting range for S and F may be calculated such that the cycle time is L_{A} or less. In this way, the setting range of the second machining condition satisfying conditions for a desired cycle time can be presented to the operator. In this case, S and/or F are/is designated as the second machining condition(s). Accordingly, depending on the calculation criteria, S or F, rather than I or K, may be set as the second machining condition.

As described above, the setting range calculation unit 14 in the second embodiment calculates a setting range for the second machining condition in accordance with the target values noted above. In the present embodiment, a setting range for the second machining condition is calculated such that all of the plurality of target values (allowable values) are satisfied.

Note that the target values in the second embodiment are nothing but examples. From among the components of the display device 1 of the second embodiment, some of the upper-limit-value acquisition unit 31, the target chip-length acquisition unit 32, the target surface-roughness acquisition unit 33, the target variation acquisition unit 34, the cycle-time target acquisition unit 35, and the cycle-time analysis unit 36 may be omitted. Alternatively, a component for acquiring a target value to be set for another parameter may be further provided.

For example, target values can be set for various parameters that change with S, F, I, and K as variables, such as an allowable value for the feed speed, an allowable value pertaining to a tool, an allowable value pertaining to the frequency parameter, an allowable value pertaining to the amplitude parameter, and an allowable value for the air cut amount (chip shredding certainty). When a setting range can be theoretically calculated between these indicator values and S, F, I, and K, the calculation may be performed on the basis of a corresponding calculation theoretical formula. If this is not the case, a setting range may be calculated in accordance with output values of a learning model based on the past performance between the indicator values and S, F, I, and K, values from a database, or the numerical calculation noted above.

Depending on the calculation criterion, all of S, F, I, and K may not need to be selected as first and second machining conditions, but some of said parameters may be selected as first and second machining conditions.

### Third Embodiment

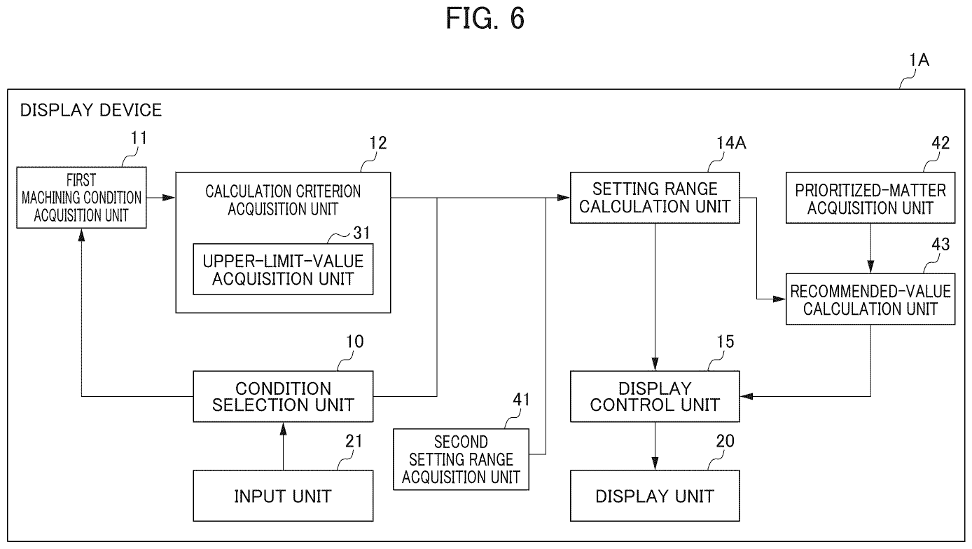

The following describes a display device 1A according to a third embodiment. FIG. 6 is a functional block diagram of a display device 1A for a machine tool according to the third embodiment.

As depicted in FIG. 6, the display device 1A includes a condition selection unit 10, a first machining condition acquisition unit 11, a calculation criterion acquisition unit 12, an upper-limit-value acquisition unit 31, a setting range calculation unit 14A, a display control unit 15, a second setting range acquisition unit 41, a prioritized-matter acquisition unit 42, and a recommended-value calculation unit 43 as functional units.

Removing the second setting range acquisition unit 41, the setting range calculation unit 14A, the prioritized-matter acquisition unit 42, and the recommended-value calculation unit 43 from the components of the display device 1A will provide a similar configuration to the first embodiment. The following descriptions are given on the assumption that, in the third embodiment, “spindle rotation number S=2000,” “feed speed F=0.10,” and “oscillation frequency multiplying factor I=1.5” are set as first machining conditions, and an oscillation amplitude multiplying factor K is set as a second machining condition, as in the first embodiment.

The second setting range acquisition unit 41 acquires a second setting range for the second machining condition. The second setting range is input by the operator or calculated or preset by, for example, a control device for the display device 1 or the machine tool. The second setting range is set for each of the machining conditions. For example, the second setting range is a recommended upper limit value, a recommended lower limit value, or a recommended range. In this example, the second setting range acquisition unit 41 acquires a second setting range of 0.8 to 1.5 as a recommended range to be set for the oscillation amplitude multiplying factor K, which is the second machining condition. The second setting range of 0.8 to 1.5 is output to the setting range calculation unit 14A.

As in the first embodiment, the setting range calculation unit 14A first calculates a setting range for the second machining condition on the basis of the first machining conditions and the calculation criteria (numerical expressions (1) and (2). In this example, the setting range calculation unit 14A calculates a setting range of 1.0 to 2.0 for the oscillation amplitude multiplying factor K, i.e., the second machining condition.

Then, the setting range calculation unit 14A compares the calculated setting range of 1.0 to 2.0 of the oscillation amplitude multiplying factor K with the second setting range of 0.8 to 1.5 acquired by the second setting range acquisition unit 41. The setting range calculation unit 14A performs recalculation for correcting the setting range of 1.0 to 1.5 of the oscillation amplitude multiplying factor K on the basis of the range of overlap between the setting range of 1.0 to 2.0 of the oscillation amplitude multiplying factor K and the second setting range of 0.8 to 1.5. In this example, the setting range calculation unit 14A outputs the setting range of 1.0 to 1.5 of the oscillation amplitude multiplying factor K as the corrected setting range of the second machining condition.

The prioritized-matter acquisition unit 42 acquires a prioritized matter that is input by the operator or calculated or preset by, for example, a control device for the display device 1 or the machine tool. The prioritized matter is a calculation criterion for calculating a recommended value within the setting range of the second machining condition. In this example, achieving a machining operation with the acceleration ((K×F)×(2π×S×I)²/2) minimized is set as the prioritized matter.

The recommended-value calculation unit 43 calculates a recommended value on the basis of the prioritized matter acquired by the prioritized-matter acquisition unit 42 and the setting range of the second machining condition output by the setting range calculation unit 14A. At the recommended value, the acceleration ((K×F)×(2πS×I)²/2) is minimized. In this example, the recommended-value calculation unit 43 outputs “oscillation amplitude multiplying factor K=1.0” as the recommended value. The display control unit 15 outputs the recommended value to the display unit 20 as the setting range of the second machining condition. The display control unit 15 may display, together with the recommended value, the setting range on the basis of which the recommended value has been calculated.

The display device 1A according to the third embodiment described so far further includes a second setting range acquisition unit 41 that acquires, for the second machining condition, a second setting range differing from the setting range calculated for the second machining condition by the setting range calculation unit 14A. The setting range calculation unit 14A calculates a setting range for the second machining condition, with the second setting range acquired by the second setting range acquisition unit 41 being reflected in the calculated setting range. Accordingly, the setting range of the second machining condition can be presented to the operator, with a range that has been set for the second machining condition in view of another advantage being reflected in the presented setting range.

In the third embodiment, the display device 1A further includes a prioritized-matter acquisition unit 42 that acquires a prioritized matter for uniquely calculating a recommended value, and a recommended-value calculation unit 43 that calculates a recommended value for the second machining condition on the basis of the prioritized matter and a setting range calculated for the second machining condition by the setting range calculation unit 14A. Accordingly, the operator can grasp the unique recommended value satisfying the requirement set by the prioritized matter, and thus can more easily set machining conditions without troubles with selecting a numerical value from the setting range.

### Fourth Embodiment

In the embodiments noted above, machining conditions are not limited to numerical values, but may be prescribed numerical ranges. The following describes a fourth embodiment, in which at least one of first machining conditions is a numerical range. Note that the configuration of the display device 1 of the fourth embodiment is also similar to that in the first embodiment.

In the fourth embodiment, a spindle rotation number S, a feed speed F, and a frequency multiplying factor I are set as first machining conditions in accordance with, for example, a user operation or the setting of the display device 1. Assume that, from among the first machining conditions, “spindle rotation number S=2000” and “feed speed F=0.10” have been decided on but a numerical value has not been set for the frequency multiplying factor I.

The first machining condition acquisition unit 11 acquires the numerical values that have been decided on, i.e., “spindle rotation number S=2000” and “feed speed F=0.10.” Next, on the basis of preset calculation criteria, the first machining condition acquisition unit 11 decides on a setting range for the frequency multiplying factor I set as a first machining condition. In this example, the calculation criteria are achieving an oscillation operation without exceeding an upper-limit frequency value, and limiting a surface-roughness variation indicator to a certain value or lower. For example, in accordance with the numerical expressions below, a range of 1.3 to 1.7 is calculated as a setting range for the frequency multiplying factor I set as a first machining condition. Thus, the first machining conditions are “S=2000,” “F=0.10,” and “I=1.3 to 1.7.”

As in the first embodiment, the calculation criterion acquisition unit 12 acquires, as calculation criteria, two matters of achieving an oscillation operation capable of causing chip shredding and also achieving the oscillation operation without the upper-limit acceleration value being exceeded. The setting range calculation unit 14 calculates a setting range for the second machining condition on the basis of the calculation criteria (numerical expressions (1) and (2)) acquired by the calculation criterion acquisition unit 12. For example, “K=1.236 to 1.557” is calculated as a setting range for K in consideration of the variation of “I=1.3 to 1.7.”

The display control unit 15 displays “K=1.236 to 1.557” on the display unit 20 as the setting range of the second machining condition. For further improvement of the operator convenience, the display control unit 15 may also display the setting range of “I=1.3 to 1.7” of a first machining condition together with the setting range of the second machining condition (K=1.236 to 1.557).

In the fourth embodiment described above, the first machining condition acquisition unit 11 acquires at least one of the first machining conditions in the form of a setting range for the first machining condition, and the setting range calculation unit 14 calculates a setting range for the second machining condition on the basis of at least calculation criteria and the setting range of the first machining condition. Accordingly, even if a numerical value is not decided on uniquely for a first machining condition, a setting range is calculated for the first machining condition, and the setting range of a second machining condition can be presented to the operator, with the setting range of the first machining condition being reflected in the setting range of the second machining condition.

The present disclosure is not limited to the above-described embodiments or variations, and encompasses variations and improvements with which objects of the present disclosure can be achieved.

The following additional remarks are further disclosed with respect to the above-described embodiments and variations.

### [Additional Remark 1]

A display device (1, 1A) for a machine tool that performs oscillation machining while causing a cutting tool and a workpiece to oscillate relative to each other, the display device (1, 1A) including:
a first machining condition acquisition unit (11) that acquires, as a first machining condition, at least one from among a spindle rotation number, a feed speed, a frequency parameter, or an amplitude parameter included in machining conditions;
a calculation criterion acquisition unit (12, 12A) that acquires two or more calculation criteria for calculating a setting range for a second machining condition that is at least one machining condition not acquired as the first machining condition from among the machining conditions; a setting range calculation unit (14, 14A) that calculates a setting range for the second machining condition on the basis of the first machining condition and the calculation criteria; and
a display control unit (15) that displays the setting range of the second machining condition on a display unit (20).

### [Additional Remark 2]

In the display device (1, 1A) for the machine tool, the calculation criterion acquisition unit (12) acquires at least a calculation criterion for calculating, for the second machining condition, a setting range such that a machining operation based on at least the second machining condition can cause chip shredding.

### [Additional Remark 3]

The display device (1, 1A) for the machine tool, the display device further including an upper-limit-value acquisition unit (31) that acquires an upper limit value for a parameter set for oscillation machining, and the calculation criterion acquisition unit (12, 12A) acquires at least a calculation criterion for calculating, for the second machining condition, a setting range such that an oscillation parameter calculated on the basis of at least the second machining condition assumes a value corresponding to the upper limit value.

### [Additional Remark 4]

The display device (1) for the machine tool, the display device further including
a target chip-length acquisition unit (32) that acquires a target chip length, and
the calculation criterion acquisition unit (12A) acquires at least a calculation criterion for calculating, for the second machining condition, a setting range such that a chip length calculated on the basis of at least the second machining condition assumes a value corresponding to the target chip length.

### [Additional Remark 5]

The display device (1) for the machine tool, the display device further including
a target surface-roughness acquisition unit (33) that acquires target surface roughness, and
the calculation criterion acquisition unit (12A) acquires at least a calculation criterion for calculating, for the second machining condition, a setting range such that surface roughness calculated on the basis of at least the second machining condition assumes a value corresponding to the target surface roughness.

### [Additional Remark 6]

The display device (1) for the machine tool, the display device further including
a target variation acquisition unit (34) that acquires a target value for a variation indicator pertaining to variations between to-be-machined surfaces in the difference in surface roughness between workpiece phases, wherein the calculation criterion acquisition unit (12A) acquires at least a calculation criterion for calculating, for the second machining condition, a setting range such that the variation indicator calculated from at least the second machining condition assumes a value corresponding to the target value.

### [Additional Remark 7]

The display device (1) for the machine tool, the display device further including:
a cycle-time target value acquisition unit (35) that acquires a cycle-time target value; and
a cycle-time analysis unit (36) that performs cycle time analysis, and
the calculation criterion acquisition unit (12A) acquires at least a calculation criterion for calculating, for the second machining condition, a setting range such that at least the second machining condition and a cycle time calculated by the cycle-time analysis unit assume values corresponding to the cycle-time target value.

### [Additional Remark 8]

The display device (1A) for the machine tool, the display device further including
a second setting range acquisition unit (41) that acquires, for the second machining condition, a second setting range differing from the setting range calculated for the second machining condition by the setting range calculation unit (14A), and
the setting range calculation unit (14A) calculates a setting range for the second machining condition, with the second setting range acquired by the second setting range acquisition unit (41) being reflected in the calculated setting range.

### [Additional Remark 9]

The display device (1A) for the machine tool, the display device further including:
a prioritized-matter acquisition unit (42) that acquires a prioritized matter for uniquely calculating a recommended value; and
a recommended-value calculation unit (43) that calculates the recommended value for the second machining condition on the basis of the prioritized matter and the setting range calculated for the second machining condition by the setting range calculation unit (14A).

### [Additional Remark 10]

In the display device (1, 1A) for the machine tool, the first machining condition acquisition unit (11) acquires at least one of the first machining conditions as a setting range for a first machining condition, and the setting range calculation unit (14) calculates a setting range for the second machining condition on the basis of at least the calculation criteria and the setting range of the first machining condition.

### [Additional Remark 11]

The display device (1, 1A) for the machine tool, the display device further including
a condition selection unit (10) that selects the first machining condition and the second machining condition from the machining conditions.

### [Additional Remark 12]

The display device (1, 1A) for the machine tool, the display device further including
an input unit (21) with which an operator selects any of the machining conditions, and
the condition selection unit (10) selects a machining condition selected using the input unit (21) as the second machining condition, and selects a machining condition differing from the one selected using the input unit (21) as the first machining condition.

### [Additional Remark 13]

A program for causing a computer (1, 1A) for a machine tool that performs oscillation machining while causing a cutting tool and a workpiece to oscillate relative to each other to implement:
a first machining condition acquisition function of acquiring, as a first machining condition, at least one from among a spindle rotation number, a feed speed, a frequency parameter, or an amplitude parameter included in machining conditions; a calculation criterion acquisition function of acquiring two or more calculation criteria for calculating, on the basis of the first machining condition, a setting range for a second machining condition that is at least one machining condition not acquired as the first machining condition from among the machining conditions; and
a setting range calculation function of calculating a setting range for the second machining condition on the basis of the first machining condition and the calculation criteria.

### EXPLANATION OF REFERENCE NUMERALS

1: Display device for machine tool
10: Condition selection unit
11: First machining condition acquisition unit
12, 12A: Calculation criterion acquisition unit
14, 14A: Setting range calculation unit
15: Display control unit
20: Display unit
21: Input unit
31: Upper-limit-value acquisition unit
32: Target chip-length acquisition unit
33: Target surface-roughness acquisition unit
34: Target variation acquisition unit
35: Cycle-time target acquisition unit
36: Cycle-time analysis unit
41: Second setting range acquisition unit
42: Prioritized-matter acquisition unit
43: Recommended-value calculation unit

1. A display device for a machine tool that performs oscillation machining while causing a cutting tool and a workpiece to oscillate relative to each other, the display device comprising:
a first machining condition acquisition unit that acquires, as a first machining condition, at least one from among a spindle rotation number, a feed speed, a frequency parameter, or an amplitude parameter included in machining conditions;
a calculation criterion acquisition unit that acquires two or more calculation criteria for calculating a setting range for a second machining condition that is at least one machining condition not acquired as the first machining condition from among the machining conditions;
a setting range calculation unit that calculates a setting range for the second machining condition on a basis of the first machining condition and the calculation criteria; and
a display control unit that displays the setting range of the second machining condition on a display unit.

2. The display device for the machine tool according to claim 1, wherein the calculation criterion acquisition unit acquires at least a calculation criterion for calculating, for the second machining condition, a setting range such that a machining operation based on at least the second machining condition can cause chip shredding.

3. The display device for the machine tool according to claim 1, the display device further comprising:
an upper-limit-value acquisition unit that acquires an upper limit value for a parameter set for oscillation machining, wherein
the calculation criterion acquisition unit acquires at least a calculation criterion for calculating, for the second machining condition, a setting range such that an oscillation parameter calculated on a basis of at least the second machining condition assumes a value corresponding to the upper limit value.

4. The display device for the machine tool according to claim 1, the display device further comprising:
a target chip-length acquisition unit that acquires a target chip length, wherein
the calculation criterion acquisition unit acquires at least a calculation criterion for calculating, for the second machining condition, a setting range such that a chip length calculated on a basis of at least the second machining condition assumes a value corresponding to the target chip length.

5. The display device for the machine tool according to claim 1, the display device further comprising:
a target surface-roughness acquisition unit that acquires target surface roughness, wherein
the calculation criterion acquisition unit acquires at least a calculation criterion for calculating, for the second machining condition, a setting range such that surface roughness calculated on a basis of at least the second machining condition assumes a value corresponding to the target surface roughness.

6. The display device for the machine tool according to claim 1, the display device further comprising:
a target variation acquisition unit that acquires a target value for a variation indicator pertaining to variations between to-be-machined surfaces in a difference in surface roughness between workpiece phases, wherein
the calculation criterion acquisition unit acquires at least a calculation criterion for calculating, for the second machining condition, a setting range such that the variation indicator calculated from at least the second machining condition assumes a value corresponding to the target value.

7. The display device for the machine tool according to claim 1, the display device further comprising:
a cycle-time target value acquisition unit that acquires a cycle-time target value; and
a cycle-time analysis unit that performs cycle time analysis, wherein
the calculation criterion acquisition unit acquires at least a calculation criterion for calculating, for the second machining condition, a setting range such that at least the second machining condition and a cycle time calculated by the cycle-time analysis unit assume values corresponding to the cycle-time target value.

8. The display device for the machine tool according to claim 1, the display device further comprising:
a second setting range acquisition unit that acquires, for the second machining condition, a second setting range differing from the setting range calculated for the second machining condition by the setting range calculation unit, wherein
the setting range calculation unit calculates a setting range for the second machining condition, with the second setting range acquired by the second setting range acquisition unit being reflected in the calculated setting range.

9. The display device for the machine tool according to claim 1, the display device further comprising:
a prioritized-matter acquisition unit that acquires a prioritized matter for uniquely calculating a recommended value; and
a recommended-value calculation unit that calculates the recommended value for the second machining condition on a basis of the prioritized matter and the setting range calculated for the second machining condition by the setting range calculation unit.

10. The display device for the machine tool according to claim 1, wherein
the first machining condition acquisition unit acquires at least one of the first machining conditions as a setting range for a first machining condition, and
the setting range calculation unit calculates a setting range for the second machining condition on a basis of at least the calculation criteria and the setting range of the first machining condition.

11. The display device for the machine tool according to claim 1, the display device further comprising: a condition selection unit that selects the first machining condition and the second machining condition from the machining conditions.

12. The display device for the machine tool according to claim 11, the display device further comprising:
an input unit with which an operator selects any of the machining conditions, wherein
the condition selection unit selects a machining condition selected using the input unit as the second machining condition, and selects a machining condition differing from the one selected using the input unit as the first machining condition.

13. A non-transitory computer-readable medium storing a program for causing a computer for a machine tool that performs oscillation machining while causing a cutting tool and a workpiece to oscillate relative to each other to implement:
a first machining condition acquisition function of acquiring, as a first machining condition, at least one from among a spindle rotation number, a feed speed, a frequency parameter, or an amplitude parameter included in machining conditions;
a calculation criterion acquisition function of acquiring two or more calculation criteria for calculating a setting range for a second machining condition that is at least one machining condition not acquired as the first machining condition from among the machining conditions; and
a setting range calculation function of calculating a setting range for the second machining condition on a basis of the first machining condition and the calculation criteria.
